(19) United States
(12) Patent Application Publication
(10) Pub. No.: US 2025/0141024 A1
(43) Pub. Date: May 1, 2025

(54) Battery Module Comprising End Plate Cap and Battery Pack Comprising the Same

(71) Applicant: SK On Co., Ltd., Seoul (KR)

(72) Inventors: Sun Ho JANG, Daejeon (KR); Chan Ho PARK, Daejeon (KR); Moo Han BAEK, Daejeon (KR); Woo Jin LEE, Daejeon (KR)

(21) Appl. No.: 18/914,440

(22) Filed: Oct. 14, 2024

(30) Foreign Application Priority Data
Oct. 27, 2023 (KR) 10-2023-0145759
May 8, 2024 (KR) 10-2024-0060439

(51) Int. Cl. H01M 50/262; H01M 10/48; H01M 50/103; H01M 50/15; H01M 50/209; H01M 50/503; H01M 50/507

(52) U.S. Cl. CPC H01M 50/262; H01M 10/482; H01M 50/103; H01M 50/15; H01M 50/209; H01M 50/503; H01M 50/507

(57) ABSTRACT

A battery module is disclosed. In some implementations, the battery module includes: a cell assembly including a plurality of battery cells; a busbar assembly including a busbar electrically connected to at least one of the plurality of battery cells, and a busbar frame disposed on the cell assembly and supporting the busbar; an end plate disposed on each of two sides of the cell assembly; and an end plate cap covering at least a portion of the end plate and connected to the busbar and the busbar frame.

### CROSS-REFERENCE TO RELATED APPLICATION(S)

This patent document claims the priority and benefits of Korean Patent Applications No. 10-2024-0060439 filed on May 8, 2024, and No. 10-2023-0145759 filed on Oct. 27, 2023, the disclosure of which is incorporated herein by reference in its entirety.

### TECHNICAL FIELD

The disclosure and implementations disclosed in this patent document generally relate to a battery module comprising an end plate cap and a battery pack comprising the same.

### BACKGROUND

Unlike a primary battery, a secondary battery may be charged and discharged, and thus may be applied to devices within various fields such as a digital camera, a mobile phone, a laptop personal computer (PC), a hybrid vehicle, an electric vehicle, and an energy storage system (ESS). The secondary battery may be a lithium-ion battery, a nickel-cadmium battery, a nickel-metal hydride battery, or a nickel-hydrogen battery.

The secondary battery may be manufactured as a flexible pouch-type battery cell or a rigid prismatic or cylindrical can-type battery cell. The plurality of battery cells may be formed as a stacked cell assembly.

The cell assembly may be disposed in a module housing to form a battery module, and the plurality of battery modules may be disposed in a pack frame to form a battery pack.

### SUMMARY

A battery module may include a busbar assembly including a battery cell and a busbar electrically connected to the battery cell. However, a conductive particle occurring when welding the busbar and the battery cell may cause an electrical or mechanical problem (e.g., short circuit in the battery module). In addition, the busbar may be in contact with a structure disposed on top of the battery module (e.g., top cover of the battery pack), thus causing damage to the battery module. In addition, a structural fixation of the busbar assembly may be required. However, the electrical problem may occur when the busbar assembly is mounted on a metal end plate.

In addition, the battery module may be transported to be mounted on a pack frame of the battery pack. However, the battery cell or the busbar may be damaged when a transport jig for transporting the battery module is in contact with the battery cell or the busbar. In addition, a separate component may be required to be mounted in the battery module.

The present disclosure may be implemented in some embodiments to provide a battery module which is prevented from damage (e.g., electrical shorts) caused by a conductive particle occurring when welding a battery cell and a busbar, and a battery pack comprising the same.

The present disclosure may be implemented in some embodiments to provide a battery module in which a busbar assembly is structurally fixed and a busbar is electrically insulated.

The present disclosure may be implemented in some embodiments to provide a battery module having improved manufacturing efficiency, and a battery pack comprising the same.

The present disclosure may be implemented in some embodiments to provide a battery module on which an additional component may be mounted.

The battery module and the battery pack in the present disclosure may be widely applied in a green technology field such as an electric vehicle, a battery charging station, and other solar power generation and wind power generation methods, using the battery. In addition, the battery module and the battery pack in the present disclosure may suppress air pollution and greenhouse gas emissions to thus be used in an eco-friendly electric vehicle, a hybrid vehicle, or the like, for ameliorating climate change.

A battery module of present disclosure includes a cell assembly including a plurality of battery cells, a busbar assembly including a busbar electrically connected to at least one of the plurality of battery cells, and a busbar frame disposed on the cell assembly and supporting the busbar, an end plate disposed on each of two sides of the cell assembly, and an end plate cap covering at least a portion of the end plate and connecting the busbar and the busbar frame to each other.

According to an embodiment, the busbar may be electrically connected to a module busbar disposed outside the battery module, and the end plate cap may include a protruding region configured to be inserted into the busbar and the module busbar.

According to an embodiment, the end plate cap may include a first fastening hole facing the busbar frame, the busbar frame may include a second fastening hole facing the first fastening hole, and the battery module may further include a fastening member inserted into the first fastening hole and the second fastening hole, and connecting the busbar frame and the end plate cap.

According to an embodiment, the busbar may include a plurality of busbars, and the busbar assembly may include a separation wall disposed between at least some of the plurality of busbars.

According to an embodiment, the separation wall may protrude further toward the top of the battery module than the busbar.

According to an embodiment, the battery module may further include a sensor assembly including a sensing terminal in contact with the busbar and a cable connected to the sensing terminal.

According to an embodiment, the busbar frame may include an accommodation groove for accommodating the cable.

According to an embodiment, the busbar frame may include a first sensor assembly guide accommodating at least a portion of the sensing terminal, and a second sensor assembly guide surrounding at least a portion of the cable.

According to an embodiment, at least a portion of the end plate cap may be disposed between the end plate and the busbar assembly.

According to an embodiment, the battery module may further include a band member surrounding the cell assembly and the end plate.

According to an embodiment, the end plate may include a band accommodation groove for accommodating the band member.

According to an embodiment, the end plate may include a transport groove into which a transport jig transporting the battery module is inserted.

According to an embodiment, the end plate may include a mounting hole in which a cable fixation member is mounted.

According to an embodiment, the end plate cap may include an insulating material.

A battery pack of the present disclosure includes a plurality of battery modules, and a pack frame supporting the plurality of battery modules. Each of the plurality of including a battery modules includes a cell assembly plurality of battery cells, a busbar assembly including a busbar electrically connected to at least one of the plurality of battery cells, and a busbar frame disposed on the cell assembly and connected to the busbar, an end plate disposed on each of two sides of the cell assembly, and an end plate cap covering at least a portion of the end plate and connected to the busbar and the busbar frame.

According to an embodiment, the battery pack may further include a top cover covering the plurality of battery modules, wherein the busbar includes a plurality of busbars, the busbar assembly includes a separation wall disposed between at least some of the plurality of busbars, and a distance between the separation wall and the top cover is shorter than a distance between the busbar and the top cover.

According to an embodiment, the battery pack may further include a module busbar electrically connecting the plurality of battery modules to each other, wherein the end plate cap includes a protruding region inserted into the busbar and the module busbar.

According to an embodiment, the battery pack may further include a heat transmission member disposed between the plurality of battery modules and the pack frame.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is a perspective view of a battery module according to an embodiment.

FIG. 3 is an exploded perspective view of the battery module according to an embodiment.

FIG. 4 is a perspective view of a busbar assembly according to an embodiment.

FIG. 5 is a perspective view of region A in FIG. 4 according to an embodiment.

FIG. 6 is a perspective view of the battery module including a sensor assembly according to an embodiment.

FIG. 7 is a perspective view of an end plate and an end plate cap according to an embodiment.

FIG. 8 is a perspective view of the battery module for explaining combination of the end plate, the end plate cap, and the busbar assembly.

FIG. 9 is a perspective view of the battery module for explaining combination of a band member and the end plate according to an embodiment.

FIG. 10 is a perspective view for explaining a movement of the battery module using a transport jig according to an embodiment.

FIG. 11 is a perspective view of the battery module including a cable fixation device according to an embodiment.

FIG. 12 is an exploded perspective view of a battery pack according to an embodiment.

FIG. 13 is a perspective view of the battery pack comprising a module busbar according to an embodiment.

### DETAILED DESCRIPTION

Hereinafter, embodiments of the present disclosure are described in detail with reference to the accompanying drawings. However, the embodiments are only exemplary, and the present disclosure is not limited to the specific embodiments exemplary described.

Terms or words used in the specification and claims described below are not to be construed as limited to their general or dictionary meanings. The terms or words will be interpreted as meanings and concepts consistent with the spirit of the present disclosure based on a principle that inventors may appropriately define the concepts of the terms in order to explain their inventions in the best mode.

Therefore, the embodiments described in the specification and the configurations shown in the drawings only exemplify the some embodiments, and do not represent all of the spirits of the present disclosure. Therefore, the present disclosure should be construed as including all the various equivalents and substitutions included in the spirit and scope of the present disclosure at the time of filing this application.

The description omits details of the known function and structure, which may obscure the gist of the present disclosure. Further, some components shown in the accompanying drawings are exaggerated, omitted, or schematically shown, and the size of each component does not exactly reflect the real size thereof.

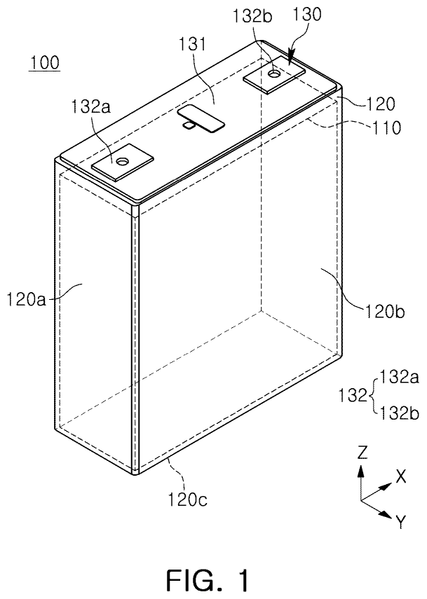

FIG. 1 is a perspective view of a battery cell according to an embodiment.

Referring to FIG. 1, a battery cell 100 may be a secondary battery cell (e.g., prismatic secondary battery cell). For example, the battery cell 100 may be a lithium ion battery, and is not limited thereto. For example, the battery cell 100 may be a nickel-cadmium electric battery, a nickel-metal hydride battery, or a nickel-hydrogen battery, which may be charged and discharged. The battery cell 100 may include an electrode assembly 110, a case 120, and a cap assembly 130.

The electrode assembly 110 may include a cathode plate, an anode plate, and a separator. The separator may prevent contact between the cathode plate and the anode plate. Those skilled in the art may understand that the electrode assembly 110 may be manufactured using a variety of methods. According to example embodiments, the electrode assembly may be formed by repeatedly disposing the cathode, the anode, and the separator. In some embodiments, the electrode assembly may be a winding type, a stacking type, a Z-fold type, or a stack-folding type.

The case 120 may form at least a portion of an exterior of the battery cell 100 and may accommodate the electrode assembly. For example, the case 120 may provide a space for accommodating the electrode assembly 110 and an electrolyte. According to an embodiment, the case 120 may include aluminum and/or stainless steel. The case 120 may be referred to as a can or a housing. In an embodiment, the case 120 may substantially have a shape of a rectangular parallelepiped, at least a portion of which is open. The case 120 may be substantially formed in the rectangular parallelepiped shape. For example, the case 120 may include a plurality of sides (e.g., narrow side 120a, a wide side 120b, and a back side 120c).

The cap assembly 130 may be coupled to the case 120. For example, the cap assembly 130 may accommodate the electrode assembly 110 and the electrolyte, together with the case 120.

The cap assembly 130 may include a plurality of components. For example, the cap assembly 130 may include a cap plate 131 coupled to the case 120 and sealing the case 120, and a terminal plate 132 electrically connected to the electrode assembly 110.

The terminal plate 132 may have either a cathode polarity or an anode polarity. For example, the terminal plate 132 may include a first terminal plate 132a electrically connected to the cathode plate of the electrode assembly 110 and a second terminal plate 132b electrically connected to the anode plate of the electrode assembly 110. According to an embodiment, the first terminal plate 132a and the second terminal plate 132b may substantially be arranged to be parallel to each other.

The components of the cap assembly 130 described above are only an embodiment. Accordingly, some of the components of the cap assembly 130 may be omitted or other components not described herein may be added. For example, the cap assembly 130 may include an electrolyte inlet, an electrolyte sealing member, a current collector, an insulating plate, a rivet terminal, and/or a gasket.

A shape of the battery cell 100 shown in FIG. 1 is exemplary. For example, the size of the battery cell 100 and/or a shape of the terminal plate 132 may depend on a design of the battery cell 100.

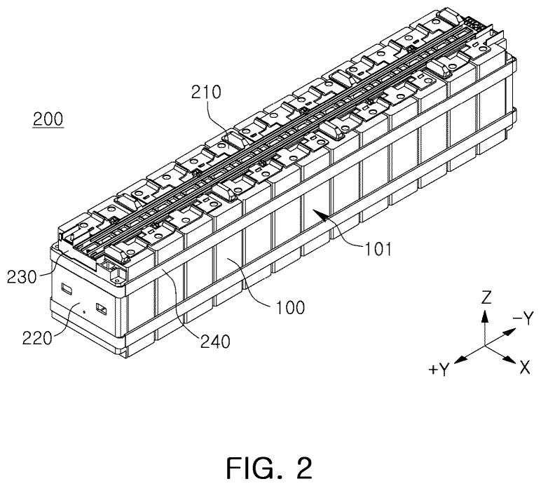

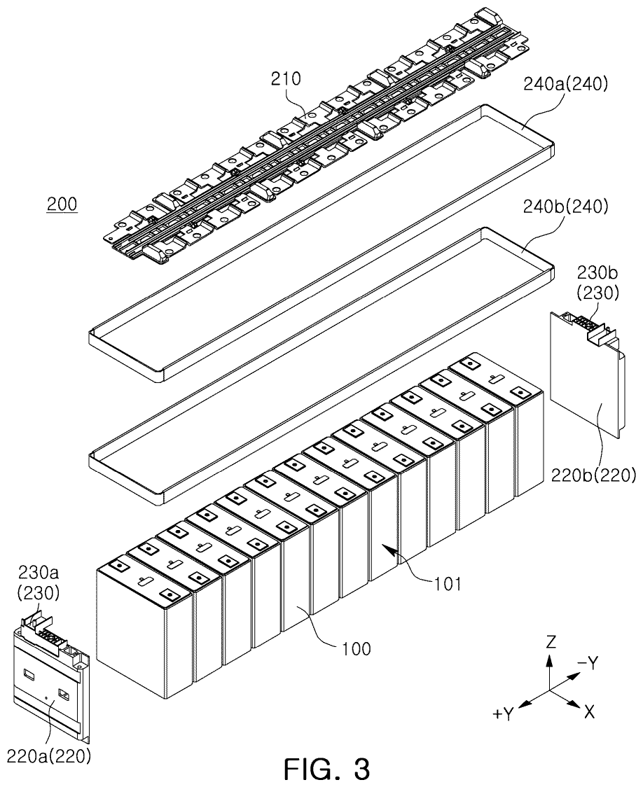

FIG. 2 is a perspective view of a battery module according to an embodiment. FIG. 3 is an exploded perspective view of the battery module according to an embodiment.

Referring to FIGS. 2 and/or 3, a battery module 200 may include a cell assembly 101, a busbar assembly 210, an end plate 220, and an end plate cap 230.

The cell assembly 101 may include the plurality of battery cells 100. The description of the battery cell 100 in FIG. 1 may be applied to the battery cell 100 in FIGS. 2 and 3. The plurality of battery cells 100 may be arranged in a first direction (e.g., Y-axis direction). In an embodiment, the cell assembly 101 may include a buffer pad (not shown) disposed between at least some of the plurality of battery cells 100. In an embodiment, the cell assembly 101 may include an insulating plate (not shown) disposed between the end plate 220 and the battery cell 100 disposed at the outermost portion of the plurality of battery cells 100.

The busbar assembly 210 may be connected to the battery cell 100. For example, at least a portion of the busbar assembly 210 may be joined to the battery cell 100, and electrically connected to the battery cell 100. A current in the battery cell 100 may be transmitted externally from the battery module 200 through the busbar assembly 210. The busbar assembly 210 may be disposed on the top of the cell assembly 101 (e.g., in Z-axis direction). In an embodiment, the busbar assembly 210 may be referred to as an internal busbar assembly (IBA).

The end plate 220 may be disposed on each of two sides of the cell assembly 101. For example, the end plate 220 may include a first end plate 220a disposed on one side of the cell assembly 101 and a second end plate 220b disposed on the other side of the cell assembly 101. The cell assembly 101 may be disposed between the first end plate 220a and the second end plate 220b.

The end plate 220 may structurally fix the cell assembly 101. For example, the end plate 220 may be connected to a band member 240. The end plate 220 may fix the cell assembly 101, together with the band member 240. The cell assembly 101 may be surrounded by the end plate 220 and the band member 240. The end plate 220 may be provided with pressure by the band member 240. The end plate 220 may provide the pressure to the battery cell 100 disposed on each of two sides of the cell assembly 101. The battery cells 100 may be provided with a substantially constant surface pressure by the end plate 220. The battery cell 100 may be provided with surface pressure to thus have an improved lifespan. In an embodiment, the end plate 220 may include a metal (e.g., aluminum or stainless steel).

The end plate cap 230 may fix a position of the busbar assembly 210. For example, the busbar assembly 210 may be coupled or connected to the end plate cap 230. At least a portion of the end plate cap 230 may be disposed between the end plate 220 and the busbar assembly 210.

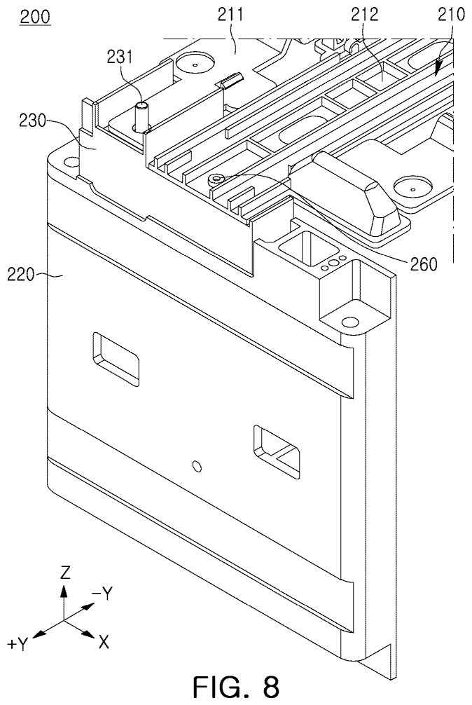

The end plate cap 230 may cover at least a portion of the end plate 220. The end plate cap 230 may be disposed on the top of the end plate 220. The end plate cap 230 may be coupled to the end plate 220. The end plate cap 230 may be selectively coupled to the end plate 220. In an embodiment, the end plate cap 230 may be fixed to the end plate 220 by using a fastening member (e.g., fastening member 260 in FIG. 8). In an embodiment, the end plate cap 230 may be coupled to the end plate 220 by using an interference fit.

The end plate cap 230 may include an insulating material. For example, the end plate cap 230 may include high molecular weight polymers and/or resins. The end plate cap 230 may prevent electrical connection between the busbar assembly 210 and the end plate 220.

The plurality of end plate caps 230 may be provided. For example, the end plate cap 230 may include a first end plate cap 230a covering the first end plate 220a and a second end plate cap 230b covering the second end plate 220b.

The band member 240 may fix the positions of the cell assembly 101 and the end plate 220. For example, the band member 240 may surround the cell assembly 101 and the end plate 220.

The number of the band members 240 may be selectively designed. In an embodiment, the band member 240 may include the plurality of band members 240a and 240b. For example, the band member 240 may include the first band 240a and the second band 240b substantially parallel to each other.

The band member 240 may include a material capable of providing elasticity. For example, the band member 240 may include the stainless steel. In an embodiment, the band member 240 may be referred to as a steel band or a band.

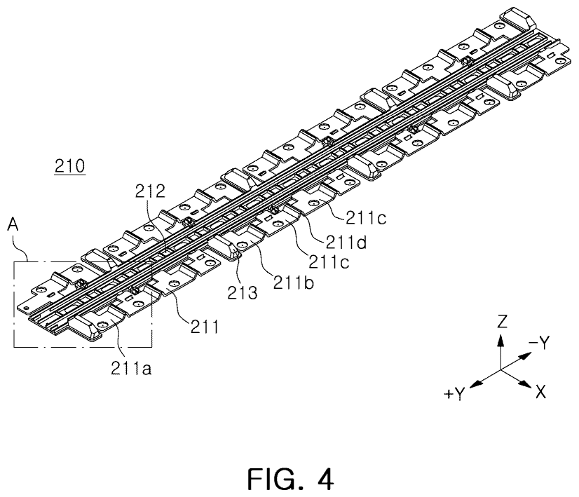

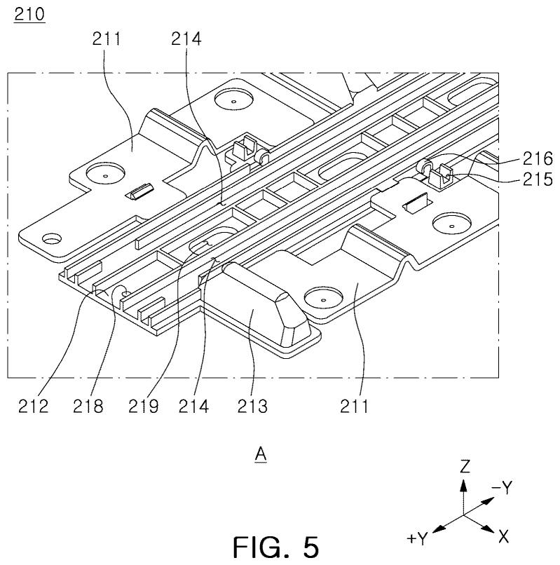

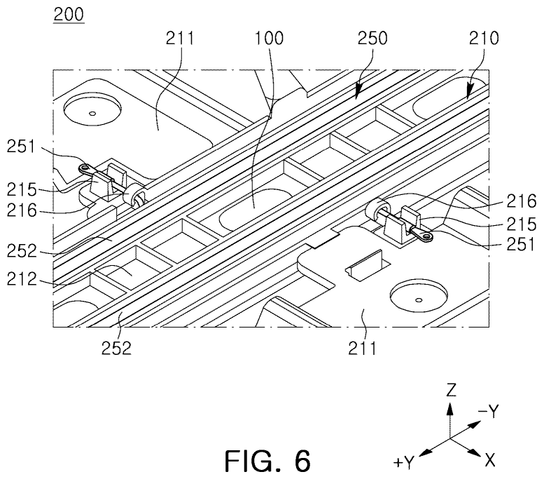

FIG. 4 is a perspective view of a busbar assembly according to an embodiment. FIG. 5 is a perspective view of region A in FIG. 4 according to an embodiment. FIG. 6 is a perspective view of the battery module including a sensor assembly according to an embodiment.

Referring to FIGS. 4, 5, and/or 6, the battery module 200 may include the battery cell 100, the busbar assembly 210, and a sensor assembly 250. The busbar assembly 210 may include a busbar 211, a busbar frame 212, and/or a separation wall 213. At least a portion of the description of the battery cell 100, the battery module 200, or the busbar assembly 210 in FIGS. 2 and 3 may be applied to the battery cell 100, the battery module 200, or the busbar assembly 210 in FIGS. 4, 5, and/or 6.

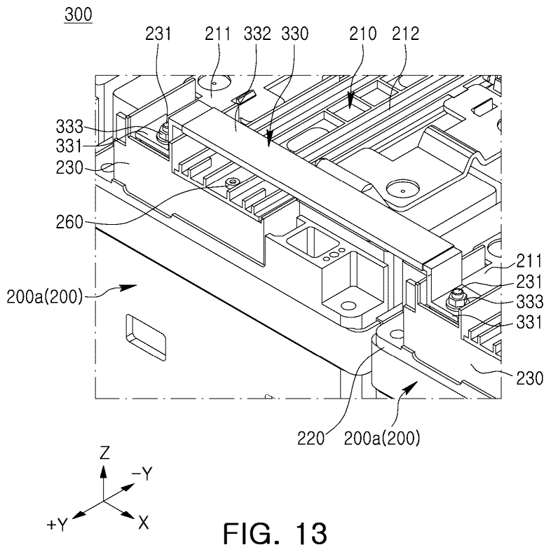

The busbar assembly 210 may be electrically connected to the battery cell (e.g., battery cell 100 in FIG. 2). The busbar assembly 210 may include the plurality of busbars 211 electrically connected to at least one of the plurality of battery cells 100. For example, the plurality of busbars 211 may include a first busbar 211a and a second busbar 211b spaced apart from the first busbar 211a. The busbar 211 may be joined to the terminal plate (e.g., terminal plate 132 in FIG. 1) of the battery cell 100, or may be coupled to thereto using the fastening member. Each of the plurality of busbars 211 may be electrically connected to at least one battery cell 100. It is possible selectively design the number of the battery cells 100 connected to one busbar (e.g., first busbar 211a or second busbar 211b) among the plurality of busbars 211. Some of the plurality of busbars 211 may be electrically connected to the outside (e.g., module busbar 330 in FIG. 13) of the battery module 200.

According to an embodiment, the busbar 211 may be formed in a shape enabling the busbar 211 to absorb swelling of the battery cell 100. For example, the busbar 211 may include a plurality of connection parts 211c respectively connected to the battery cell 100, and a buffer portion 211d disposed between the plurality of connection parts 211c. According to an embodiment, at least a portion of the buffer portion 211d may have a curved shape. For example, the buffer portion 211d may protrude toward the top of the busbar assembly 210 (e.g., in Z-axis direction) than the connection part 211c.

The busbar 211 may be deformed using the buffer portion 211d. For example, a distance between the connection parts 211c may be increased when the battery cell 100 is swollen. The buffer portion 211d may absorb at least a portion of an impact caused by the swelling of the battery cell 100. Damage to the battery module 200 may be reduced or prevented due to the deformation of the busbar 211.

The busbar assembly 210 may include the busbar frame 212 supporting the busbar 211. The busbar frame 212 may be disposed on the cell assembly 101. In an embodiment, the busbar frame 212 may be referred to as a busbar holder or a busbar support member. According to an embodiment, the busbar frame 212 may be made of the electrically insulating material. For example, the busbar frame 212 may include polymers or resins.

The busbar frame 212 may have a shape enabling the busbar frame 212 to be connected to the end plate cap (e.g., end plate cap 230 in FIG. 3). For example, the busbar frame 212 may include a second fastening hole 218 facing the end plate cap 230. The busbar frame 212 may be coupled or connected to the end plate cap 230 by using the fastening member (e.g., fastening member 260 in FIG. 8) inserted into the second fastening hole 218.

The busbar frame 212 may have a shape enabling the busbar frame 212 to guide a venting gas occurring in the battery cell (e.g., battery cell 100 in FIG. 1). For example, the busbar frame 212 may include a through-hole 219 corresponding to a venting part of each of the plurality of battery cells 100. At least a portion of the gas occurring in the battery cell 100 may pass through the through-hole 219 of the busbar frame 212 to be discharged externally from the battery module 200.

The busbar assembly 210 may include the separation wall 213. The separation wall 213 may prevent an electrical short caused by a conductive particle (e.g., metal particle) occurring when joining the busbar 211 and a portion of the battery cell 100 (e.g., terminal plate 132 in FIG. 1). For example, the separation wall 213 may be disposed on one side of the busbar 211. The plurality of busbars 211 may be provided. For example, the busbar 211 may include the plurality of busbars 211. The separation wall 213 may be disposed between at least some of the plurality of busbars 211. The separation wall 213 may be disposed between the first busbar 211a and the second busbar 211b. The separation wall 213 may prevent the conductive particle, occurring in a welding process of the busbar 211, from being transferred to another busbar 211.

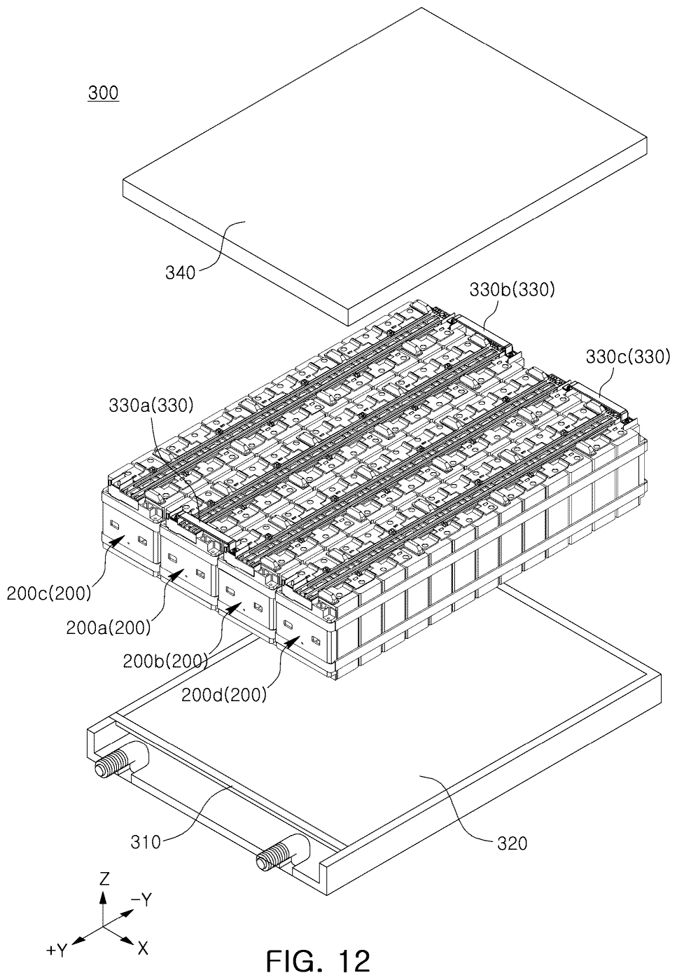

The separation wall 213 may prevent contact between the busbar 211 and another structure (e.g., top cover 340 of a battery pack 300 in FIG. 12). For example, the separation wall 213 may support the top cover 340 of the battery pack 300. The separation wall 213 may protrude toward the top of the battery module 200 (e.g., in Z-axis direction) than the busbar 211. The top of the battery module 200 may be a region where the top cover 340 of the battery pack 300 is disposed. For example, a distance between the separation wall 213 and the top cover 340 may be shorter than a distance between the busbar 211 and the top cover 340. The separation wall 213 may be in contact with an external structure of the battery module 200 (e.g., top cover 340 of the battery pack 300) before a portion of the busbar 211 (e.g., buffer portion 211d), thus preventing damage and/or short circuit occurring from the busbar 211.

In an embodiment, the separation wall 213 may be integrated with the busbar frame 212. For example, the separation wall 213 may be a portion of the busbar frame 212 that extends from the busbar frame 212 in a width direction (e.g., X-axis direction) of the busbar assembly 210.

In an embodiment, the separation wall 213 may be assembled to the busbar frame 212. For example, the separation wall 213 may be mounted on the busbar frame 212 by using the fastening member (not shown).

The shape and/or size of the separation wall 213 disclosed in the present disclosure is exemplary. In an embodiment, the separation wall 213 may have a rectangular or diamond shape. In an embodiment, the separation wall 213 may have a hollow structure with an empty interior. In an embodiment, the separation wall 213 may have a solid structure with a filled interior.

The sensor assembly 250 may detect information and/or states of the battery cell 100 and/or the battery module 200. For example, the sensor assembly 250 may detect at least one of the voltage or temperature of the battery cell 100 and/or that of the battery module 200. The sensor assembly 250 may be connected to a battery management system (BMS) to prevent overcharging of the battery cell 100 or perform voltage balancing of the battery cell 100. In an embodiment, the sensor assembly 250 may include a temperature sensor (not shown) and/or a voltage sensor.

The sensor assembly 250 may be disposed on the busbar assembly 210. For example, the sensor assembly 250 may be disposed on the busbar frame 212.

The sensor assembly 250 may include a sensing terminal 251 in contact with the busbar 211. The sensing terminal 251 may detect a voltage of the busbar 211. In an embodiment, the sensing terminal 251 may be referred to as a voltage detection terminal.

The sensor assembly 250 may include a cable 252 connected to the sensing terminal 251. The cable 252 may provide a path for transmitting a signal detected in the sensing terminal 251 externally from the sensor assembly 250. The cable 252 may transmit the signal detected at the sensing terminal 251 to a processor (not shown) or the battery management system. In an embodiment, the cable 252 may be replaced by a wire, a printed circuit board, or a flexible printed circuit board. In an embodiment, the cable 252 may be referred to as a body part.

The busbar frame 212 may accommodate the sensor assembly (e.g., sensor assembly 250 in FIG. 6). For example, the busbar frame 212 may include an accommodation groove 214 for accommodating the cable 252. At least a portion of the cable 252 may be disposed in the accommodation groove 214 of the busbar frame 212. The accommodation groove 214 may be formed in a length direction (e.g., Y-axis direction) of the busbar frame 212. The accommodation groove 214 may provide a space (e.g., passage) for seating the cable 252.

The busbar frame 212 may include sensor assembly guides 215 and 216 preventing the sensor assembly 250 from being separated. In an embodiment, the busbar frame 212 may include the first sensor assembly guide 215 accommodating at least a portion of the sensing terminal 251. At least a portion of the sensing terminal 251 may be seated on the first sensor assembly guide 215. The sensing terminal 251 may be seated on the first sensor assembly guide 215, thereby preventing the sensor assembly 250 from being separated from the busbar assembly 210. In an embodiment, the first sensor assembly guide 215 may be referred to as a cable passage or a separation prevention member.

In an embodiment, the sensor assembly guides 215 and 216 may be integrated with the busbar frame 212. In another embodiment, the sensor assembly guides 215 and 216 may be fastened or connected to the busbar frame 212.

In an embodiment, the busbar frame 212 may include the second sensor assembly guide 216 preventing the separation of the sensing terminal 251 and/or the cable 25. The second sensor assembly guide 216 may surround at least a portion of the sensing terminal 251 and/or at least a portion of the cable 252. The second sensor assembly guide 216 may prevent the sensor assembly 250 from being separated from the busbar assembly 210. Durability of the battery module 200 may be improved by the second sensor assembly guide 216. In an embodiment, the second sensor assembly guide 216 may be referred to as a hook member or the separation prevention member.

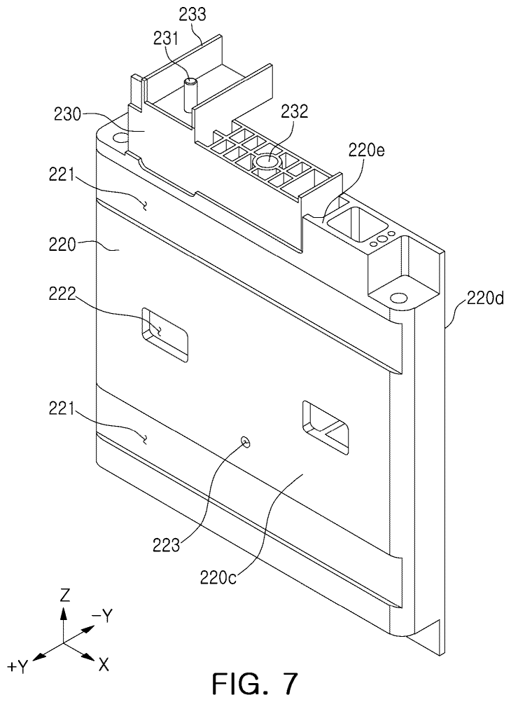

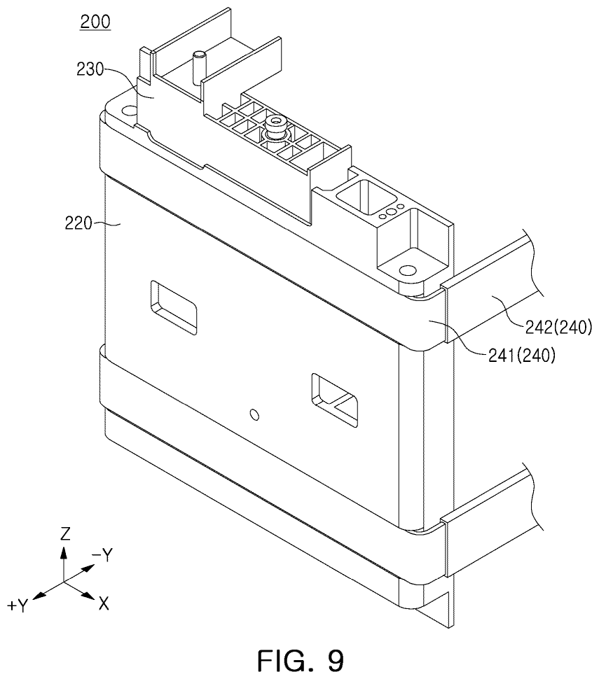

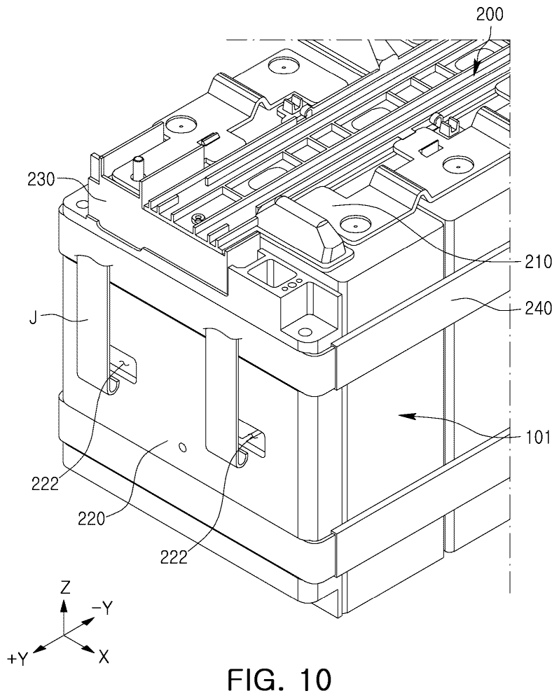

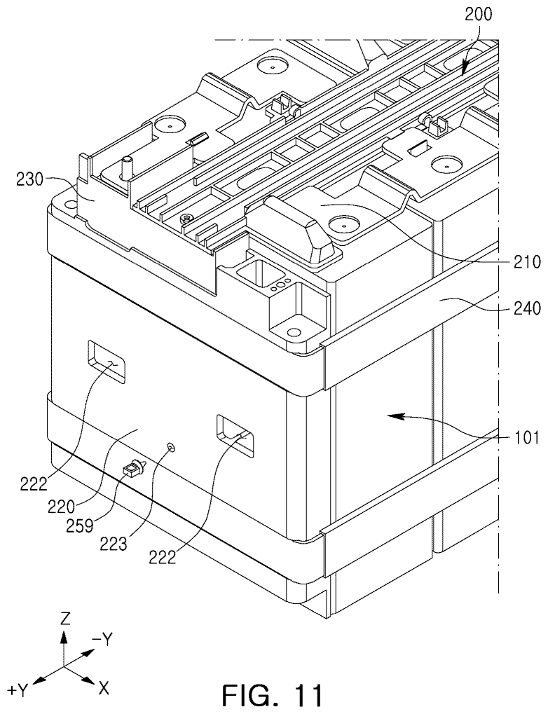

FIG. 7 is a perspective view of the end plate and the end plate cap according to an embodiment. FIG. 8 is a perspective view of the battery module for explaining combination of the end plate, the end plate cap, and the busbar assembly. FIG. 9 is a perspective view for explaining combination of the band member and the end plate according to an embodiment. FIG. 10 is a perspective view for explaining a movement of the battery module using a transport jig according to an embodiment. FIG. 11 is a perspective view of the battery module including a cable fixation device according to an embodiment.

Referring to FIGS. 7, 8, 9, 10, and/or 11, the battery module 200 may include the cell assembly 101, the busbar assembly 210, the end plate 220, the end plate cap 230, and/or the band member 240. Descriptions of the battery module 200, the cell assembly 101, the busbar assembly 210, the end plate 220, the end plate cap 230, and/or the band member 240 in FIGS. 1 through 6 may be applied to the battery module 200, the cell assembly 101, the busbar assembly 210, the end plate 220, the end plate cap 230, and/or the band member 240 in FIGS. 7 through 11.

In an embodiment, at least a portion of the end plate 220 may have a substantially flat shape. For example, the end plate 220 may include an outer surface 220c facing the outside of the battery module 200, an inner surface 220d facing the battery cell 100, and an upper surface 220e. The end plate cap 230 may cover at least a portion of the upper surface 220e of the end plate 220.

Referring to FIGS. 7 and 8, the end plate cap 230 may be coupled to the busbar assembly 210. The end plate cap 230 may be connected to the busbar 211 and the busbar frame 212.

The end plate cap 230 may be connected to the busbar 211. The busbar 211 may be connected to the module busbar disposed outside the battery module 200 (e.g., module busbar 330 in FIG. 13). The end plate cap 230 may connect the busbar 211 and the module busbar 330 to each other. For example, the end plate cap 230 may include a protruding region 231 connected to the busbar 211 and the module busbar (e.g., module busbar 330 in FIG. 13). The protruding region 231 may be inserted into the busbar 211 and the module busbar 330. The protruding region 231 may protrude toward the top of the battery module 200. The busbar 211 and the module busbar 330 may each include a through-hole accommodating the protruding region. The busbar 211 and the module busbar 330 may be in contact with each other while accommodating the protruding region 231.

The end plate cap 230 may include a guide rib 233. The guide rib 233 may surround at least a portion of the busbar 211 and the module busbar 330. The guide rib 233 may prevent the separation and shaking of the busbar 211 and the module busbar 330. The guide rib 233 may protrude toward the top of the battery module 200.

The end plate cap 230 may be connected to the busbar frame 212. For example, the end plate cap 230 may include a fastening hole (e.g., first fastening hole 232) facing the busbar frame 212. The busbar frame 212 may include the fastening hole (e.g., second fastening hole 218 in FIG. 5) facing the first fastening hole 232 of the end plate cap 230.

The battery module 200 may include the fastening member 260 connecting the busbar frame 212 and the end plate cap 230 to each other. The fastening member 260 may be inserted into the first fastening hole 232 of the end plate cap 230 and the second fastening hole 218 of the busbar frame 212. The end plate cap 230 may be coupled to the busbar frame 212, thereby improving the durability of the battery module 200.

Referring to FIGS. 7 and 9, the position of the end plate 220 may be fixed by the band member 240. The band member 240 may maintain a shape of the battery module (e.g., battery module 200 in FIG. 2) by providing the pressure to the end plate 220. For example, the end plate 220 and the cell assembly 101 may be surrounded and fixed by the band member 240.

The end plate 220 may guide an assembly position of the band member 240. In an embodiment, the end plate 220 may include a band accommodation groove 221 for accommodating the band member 240. At least a portion of the band member 240 may be seated in the band accommodation groove 221. An assembly convenience of the band member 240 and the end plate 220 may be increased by the band accommodation groove 221. In an embodiment (not shown), the end plate 220 may include a protrusion (e.g., embossed structure) for guiding the position of the band member 240. The protrusion may be a portion of the end plate 220 that protrudes from the outer surface 220c of the end plate 220. At least a portion of the band member 240 may be surrounded by the protrusion. In an embodiment (not shown), the end plate 220 may include a pin (not shown) for guiding the position of the band member 240. The pin may be mounted on the outer surface 220c of the end plate 220. In an embodiment, the end plate 220 may include at least one of the band accommodation groove 221, the protrusion, or the pin.

A shape of the band member 240 may be selectively designed. In an embodiment, the band members 240 may be integrated with each other. In another embodiment, the band member 240 may include a plurality of components that may be welded or coupled to each other. For example, the band member 240 may include a first band region 241 in contact with the end plate 220 and a second band region 242 extending from the first band region 241 or connected to the first band region 241. At least a portion of the first band region 241 may be disposed in the band accommodation groove 221. At least a portion of the second band region 242 may face the plurality of battery cells (e.g., battery cell 100 in FIG. 3).

Referring to FIGS. 7 and 10, the battery module 200 may be moved using a transport jig J.

The end plate 220 may include a transport groove 222 into which the transport jig J is inserted. The transport jig J may be a device transporting the battery module 200. For example, the transport jig J may be moved while being inserted into the end plate 220 to thus move the battery module 200. For example, the transport jig J) may move the battery module 200 to a position for assembling the battery pack (e.g., battery pack 300 in FIG. 12).

The transport groove 222 may be a groove or a hole, formed in the outer surface 220c of the end plate 220. The transport jig J may be moved while being inserted into the transport groove 222 to thus increase a manufacturing convenience (e.g., transport convenience) of the battery module 200 and the battery pack 300.

Referring to FIGS. 7 and 11, the end plate 220 may include a mounting hole 223 in which an additional component (e.g., cable fixation member 259) is mounted. The battery module 200 may include the cable fixation member 259. The cable fixation member 259 may fix a position of at least a portion of the cable (e.g., cable 252 in FIG. 6) of the sensor assembly (e.g., sensor assembly 250 in FIG. 6) or that of a high voltage cable (not shown). The high voltage cable may be a terminal or a connection part, which may transmit the current in the battery module 200 externally from the battery module 200. The cable fixation member 259 may be mounted in the mounting hole 223 of the end plate 220. The mounting hole 223 may be the groove or the hole formed in the outer surface 220c of the end plate 220. A position of a portion of the cable 252 may be adjusted and fixed by the cable fixation member 259, thereby reducing damage to the cable 252.

FIG. 12 is an exploded perspective view of the battery pack according to an embodiment. FIG. 13 is an perspective view of the battery pack including a module busbar according to an embodiment.

Referring to FIGS. 12 and 13, the battery pack 300 may include the plurality of battery modules 200, a pack frame 310, a heat transmission member 320, the module busbar 330, and/or the top cover 340 (e.g., pack cover). The description of the battery module 200 described above may be applied to the battery module 200 in FIGS. 12 and/or 13. For example, the battery module 200 in FIGS. 12 and 13 may include the cell assembly 101, the busbar assembly 210, the end plate 220, the end plate cap 230, and/or the band member 240.

The pack frame 310 may support the components of the battery pack 300 (e.g., battery module 200). For example, the plurality of battery modules 200 may be disposed on the pack frame 310. In an embodiment, the pack frame 310 may be referred to as a bottom plate. In an embodiment, the pack frame 310 may include a cooling channel for cooling. The cooling passage may provide a path through which a refrigerant flows.

The heat transmission member 320 may be a thermally conductive pad, grease, or a thermal adhesive. For example, the battery module 200 may be attached to the pack frame 310 by using the heat transmission member 320. The heat transmission member 320 may be disposed between the pack frame 310 and the battery module 200.

The plurality of battery modules 200 may be provided. For example, the plurality of battery modules 200 may include a first battery module 200a, a second battery module 200b, a third battery module 200c, and a fourth battery module 200d. The plurality of battery modules 200a, 200b, 200c, and 200d may be arranged in a second direction (e.g., X-axis direction). The number or arrangement position of the battery modules 200 may be selectively designed.

The module busbar 330 may electrically connect the plurality of battery modules 200 to each other. For example, two ends 331 of the module busbar 330 may respectively be connected to the busbar 211 of the battery module 200. The module busbar 330 may be connected or coupled to the end plate cap 230. For example, the module busbar 330 may be inserted into the protruding region 231 of the end plate cap 230, together with the busbar 211. The module busbar 330 and the busbar 211 may be fastened to the protruding region 231 by using a nut 333. The module busbar 330 may include an insulating protection member 332 surrounding at least a portion of a surface of the module busbar 330.

The module busbar 330 may include a first module busbar 330a electrically connecting the first battery module 200a and the second battery module 200b to each other, a second module busbar 330b electrically connecting the first battery module 200a and the third battery module 200c to each other, and a third module busbar 330c connecting the second battery module 200b and the fourth battery module 200d to each other. The plurality of battery modules 200 and/or the plurality of module busbar 330 are exemplary.

As set forth above, according to an embodiment of the present disclosure, it is possible to prevent the damage caused by the conductive particle occurring in the welding process of the battery cell and the busbar.

According to an embodiment of the present disclosure, it is possible to improve the structural and electrical stability of the battery module and the battery pack.

According to an embodiment of the present disclosure, it is possible to improve the manufacturing efficiency of the battery module and the battery pack.

According to an embodiment of the present disclosure, it is possible to mount the additional components (e.g., cable fixation member) at the battery module.

Only specific examples of implementations of certain embodiments are described. Variations, improvements and enhancements of the disclosed embodiments and other embodiments may be made based on the present disclosure of this patent document.

What is claimed is:

1. A battery module comprising:
a cell assembly including a plurality of battery cells;
a busbar assembly including a busbar electrically connected to at least one of the plurality of battery cells, and a busbar frame disposed on the cell assembly and supporting the busbar;
an end plate disposed on each of two sides of the cell assembly; and
an end plate cap covering at least a portion of the end plate and connected to the busbar and the busbar frame.

2. The battery module of claim 1, wherein the busbar is electrically connected to a module busbar disposed outside the battery module, and
the end plate cap includes a protruding region configured to be inserted into the busbar and the module busbar.

3. The battery module of claim 1, wherein the end plate cap includes a first fastening hole facing the busbar frame,
the busbar frame includes a second fastening hole facing the first fastening hole, and
the battery module further includes a fastening member inserted into the first fastening hole and the second fastening hole, and connecting the busbar frame and the end plate cap to each other.

4. The battery module of claim 1, wherein the busbar includes a plurality of busbars, and
the busbar assembly includes a separation wall disposed between at least some of the plurality of busbars.

5. The battery module of claim 4, wherein the separation wall protrudes toward the top of the battery module than the busbar.

6. The battery module of claim 1, further comprising a sensor assembly including a sensing terminal in contact with the busbar and a cable connected to the sensing terminal.

7. The battery module of claim 6, wherein the busbar frame includes an accommodation groove for accommodating the cable.

8. The battery module of claim 6, wherein the busbar frame includes
a first sensor assembly guide accommodating at least a portion of the sensing terminal, and
a second sensor assembly guide surrounding at least a portion of the cable.

9. The battery module of claim 1, wherein at least a portion of the end plate cap is disposed between the end plate and the busbar assembly.

10. The battery module of claim 1, further comprising a band member surrounding the cell assembly and the end plate.

11. The battery module of claim 10, wherein the end plate includes a band accommodation groove for accommodating the band member.

12. The battery module of claim 1, wherein the end plate includes a transport groove into which a transport jig transporting the battery module is inserted.

13. The battery module of claim 1, wherein the end plate includes a mounting hole in which a cable fixation member is mounted.

14. The battery module of claim 1, wherein the end plate cap includes an insulating material.

15. The battery module of claim 1, wherein each of the plurality of battery cells includes
an electrode assembly,
a case for accommodating the electrode assembly, and
a cap assembly including a cap plate coupled to the case and sealing the case, and a terminal plate electrically connected to the electrode assembly.

16. A battery pack comprising:
a plurality of battery modules; and
a pack frame supporting the plurality of battery modules,
wherein each of the plurality of battery modules includes
a cell assembly including a plurality of battery cells,
a busbar assembly including a busbar electrically connected to at least one of the plurality of battery cells, and a busbar frame disposed on the cell assembly and connected to the busbar,
an end plate disposed on each of two sides of the cell assembly, and
an end plate cap covering at least a portion of the end plate and connected to the busbar and the busbar frame.

17. The battery pack of claim 16, further comprising a top cover covering the plurality of battery modules,
wherein the busbar includes a plurality of busbars,
the busbar assembly includes a separation wall disposed between at least some of the plurality of busbars, and
a distance between the separation wall and the top cover is shorter than a distance between the busbar and the top cover.

18. The battery pack of claim 16, further comprising a module busbar electrically connecting the plurality of battery modules to each other,
wherein the end plate cap includes a protruding region inserted into the busbar and the module busbar.

19. The battery pack of claim 16, further comprising a heat transmission member disposed between the plurality of battery modules and the pack frame.
